(19) United States
(12) Patent Application Publication
(10) Pub. No.: US 2013/0255403 A1
(43) Pub. Date: Oct. 3, 2013

(54) SAMPLING DEVICES, KITS FOR ASSEMBLING SUCH SAMPLING DEVICES, AND METHODS FOR SAMPLING BUILDING MATERIALS

(71) Applicant: Steven H. Dixon, South Salt Lake City, UT (US)

(72) Inventor: Steven H. Dixon, South Salt Lake City, UT (US)

(73) Assignee: DIXON INFORMATION INCORPORATED, South Salt Lake City, UT (US)

(21) Appl. No.: 13/433,023

(22) Filed: Mar. 28, 2012

(51) Int. Cl. G01N 1/04; G01N 19/06

(52) U.S. Cl. 73/863.23; 73/864.44

(57) ABSTRACT

Sampling devices for procuring building material samples may include a first shaft, a second shaft, a core sampler, and at least one dust inhibitor. Sampling device kits may include a second shaft, at least one core sampler for procuring building material samples and configured to connect to the second shaft, at least one of an optional handle and an optional drill chuck configured to connect to the second shaft, an optional first shaft through which the second shaft and core sampler are configured to extend, and at least one optional dust inhibitor configured to connect to the first shaft. Methods of procuring a sample of building material may include sampling devices.

### FIELD

The disclosure relates generally to sampling devices for procuring samples of building materials to test for various materials in the samples. More specifically, the disclosed embodiments relate to sampling devices that may reduce the extent to which procurement of samples exposes a user to potentially hazardous materials without contamination of the acquired samples.

### BACKGROUND

Determining whether a building was constructed of potentially hazardous materials, such as asbestos, may involve removing a sample of building materials and analyzing the sample to determine whether any of the building materials are hazardous. For example, a core sample of building materials may be procured by driving a core sampler, such as a detachable, tubular core drill bit, into a wall or a ceiling of a building and removing the core drill bit, including a core sample of the building materials that has become lodged within the detachable, tubular core sampler, from the wall or ceiling. The core sample may then be transported to appropriate facilities for testing. Driving the core sampler into the wall or ceiling of the building may produce dust and other debris, which may expose the person or persons who procure the sample or are otherwise near the sampling site while the dust is in the environment to hazardous materials.

Various dust collection devices are heretofore known to contain dust from drilling operations. One such device is illustrated in U.S. Pat. No. 2,792,199 issued May 14, 1957, to Becker et al., which is designed and constructed to collect debris during machine drilling of bolt holes in the roof of underground mines.

### BRIEF SUMMARY

In some embodiments, sampling devices configured to procure building material samples comprise a first shaft, a second shaft, a core sampler, and at least one dust inhibitor (e.g., at least one dust collector, dust shield, or dust suppressor). The first shaft comprises a proximal end and a distal end and defines a bore extending through the first shaft. The second shaft is configured for insertion into the bore at the proximal end of the first shaft and is of a length to extend through the bore. The second shaft may comprise at least one electrically insulative portion and a connector at a distal end of the second shaft. The core sampler is configured to procure a building material core sample and comprises a tube (e.g., a coring tube), a piercing edge configured to penetrate a building material at a first end of the tube, and a connector at a second, opposing end of the tube configured to connect to the connector at the distal end of the second shaft. The one or more dust inhibitors define a hole through which the core sampler is configured to extend and are configured to attach to an end of the first shaft and to abut against a building surface. The first and second shafts may be elongated members to facilitate sample procurement from overhead sites.

In other embodiments, sampling devices for procuring building material samples comprise a first shaft, a second shaft, a core sampler, and at least one dust inhibitor. The first shaft defines a bore extending through the first shaft. The second shaft is located within the bore and comprises a connector at a distal end of the second shaft. The core sampler is configured to procure a building material core sample and comprises a tube, a piercing edge configured to penetrate a building material at a first end of the tube, and a connector at a second, opposing end of the tube configured to connect to the connector at the distal end of the second shaft. The core sampler may be a detachable and replaceable unit. The one or more dust inhibitors define a hole through which the core sampler is configured to extend and are configured to attach to an end of the first shaft and to abut against a building surface. The one or more dust inhibitors may be structured to reduce the likelihood of contaminating the detachable core sampler, for which an unused replacement may be interchanged for each new sample.

In still other embodiments, sampling devices for procuring building material samples comprise a core sampler and a dust inhibitor. The core sampler is configured to procure a building material core sample and comprises a tube and a piercing edge configured to penetrate a building material at a first end of the tube. The dust inhibitor is configured to abut against a building surface and comprises a sponge through which the core sampler is configured to extend.

In still other embodiments, sampling device kits include a shaft having a threaded connection portion at a distal end thereof and a cross member at a proximal end of the shaft configured to apply a rotational force and at least one core sampler configured to procure a building material core sample comprising a tube, a piercing edge configured to penetrate a building material at a first end of the tube, and a complementary threaded connector at a second, opposing end of the tube configured to connect to the connection portion of the shaft. As one example, handle-like grips may be included at the proximal end of the shaft to provide a gripping surface when employing the sampling device to take a sample. Such handle-like grips may be made of electrically insulative material to protect a user from injury in the event the core sampler engages electrical wires in a building structure.

### BRIEF DESCRIPTION OF THE DRAWINGS

While the specification concludes with claims particularly pointing out and distinctly claiming what are regarded as embodiments of the disclosure, various features and advantages of disclosed embodiments may be more readily ascertained from the following description when read in conjunction with the accompanying drawings, in which:

FIG. 1 is a perspective view of a sampling device configured to procure building material samples;

FIG. 2 is a cross-sectional view of the sampling device of FIG. 1 in a first state;

FIG. 3 is a cross-sectional view of the sampling device of FIG. 2 in a second state;

FIG. 4 is a cross-sectional view of a dust inhibitor of the sampling device of FIG. 1;

FIG. 5 is a cross-sectional view of another embodiment of a dust inhibitor for a sampling device;

FIG. 6 is a perspective view of a sampling device kit; and

FIG. 7 is a schematic of another embodiment of a sampling device kit.

### DETAILED DESCRIPTION

The illustrations presented herein are not meant to be actual views of any particular sampling device or component thereof, but are merely idealized representations employed to describe illustrative embodiments. Thus, the drawings are not necessarily to scale. Additionally, elements common between figures may retain the same or similar numerical designation.

Disclosed embodiments relate generally to sampling devices that may enhance the ability of user to take a sample of a material (e.g., a building material). For example, embodiments of sampling devices may reduce the extent to which procurement of samples of building materials exposes a user to potentially hazardous materials. In some embodiments, sampling devices may include dust inhibitors and core samplers, which dust inhibitors may be structured to trap or contain at least some of the dust produced during procurement of samples of building materials. The dust inhibitors may be of various materials and shapes, so long as the basic purpose of such dust inhibitors is performed.

As used herein, the terms “distal” and “proximal” refer to a component's distance from a user when the component is oriented for normal operation. For example, a distal end of a component refers to an end of the component farthest from a user when the component is oriented for normal operation and a proximal end of the component refers to an end of the component closes to a user when the component is oriented for normal operation.

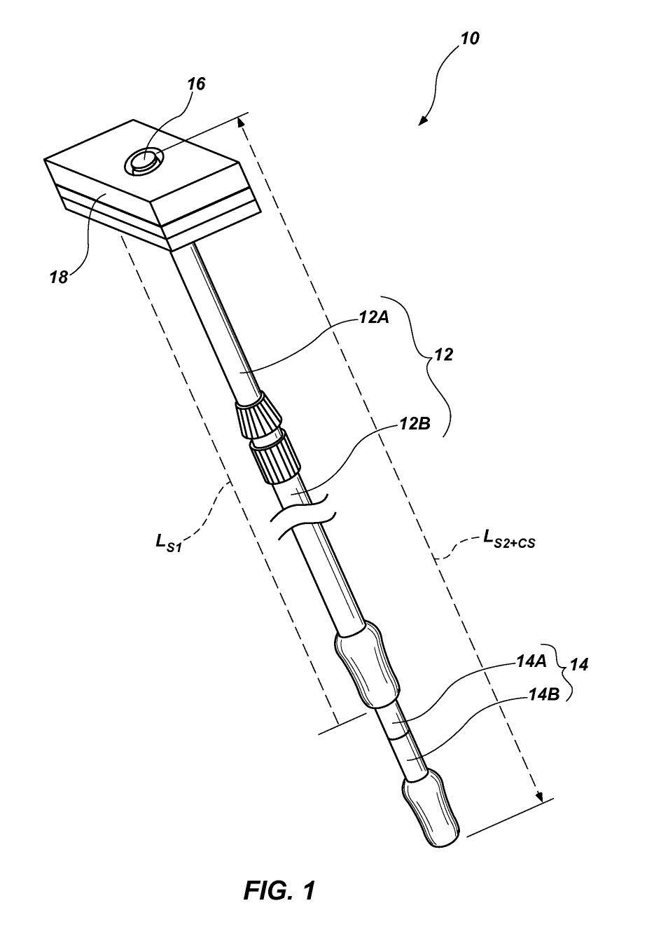

Referring to FIG. 1, a perspective view of a sampling device 10 configured to procure building material samples is shown. The sampling device 10 comprises a first shaft 12 and a second shaft 14 configured to move within the first shaft 12. A core sampler 16 (e.g., a core drill bit) configured to procure a core sample of building materials may be attached to and movable with the second shaft 14. A dust inhibitor 18 configured to reduce a quantity of dust to which a user might otherwise be exposed without the dust inhibitor 18 may be attached to the first shaft 12, and the core sampler 16 may be configured to extend through the dust inhibitor 18 to procure a core sample of building materials. The sampling device 10 may be assembled from a kit, which may include at least these components and optionally additional components, as discussed in further detail below.

In some embodiments, the first shaft 12 may be extendable. For example, the first shaft 12 may comprise a plurality of telescoping shaft members 12A and 12B, which may slide telescopically relative to one another to impart a length L_{S1} of between about 2 inches (5.1 cm) and about 20 feet (6.1 m) to the first shaft 12. In other embodiments, the first shaft 12 may have a fixed length L_{S1}. A combined length L_{S2+CS} of the second shaft 14 and the core sampler 16 may be greater than the length L_{S1} of the first shaft 12. The second shaft 14 may also be extendable in some embodiments. For example, the second shaft 14 may comprise a plurality of discrete shaft members 14A and 14B, which may be interconnected to one another to vary the combined length L_{S2+CS} of the second shaft 14 and the core sampler 16 and to maintain the combined length L_{S2+CS} of the second shaft 14 and the core sampler 16 longer than the length L_{S1} of the first shaft 12. In other embodiments, the second shaft 14 may have a fixed length.

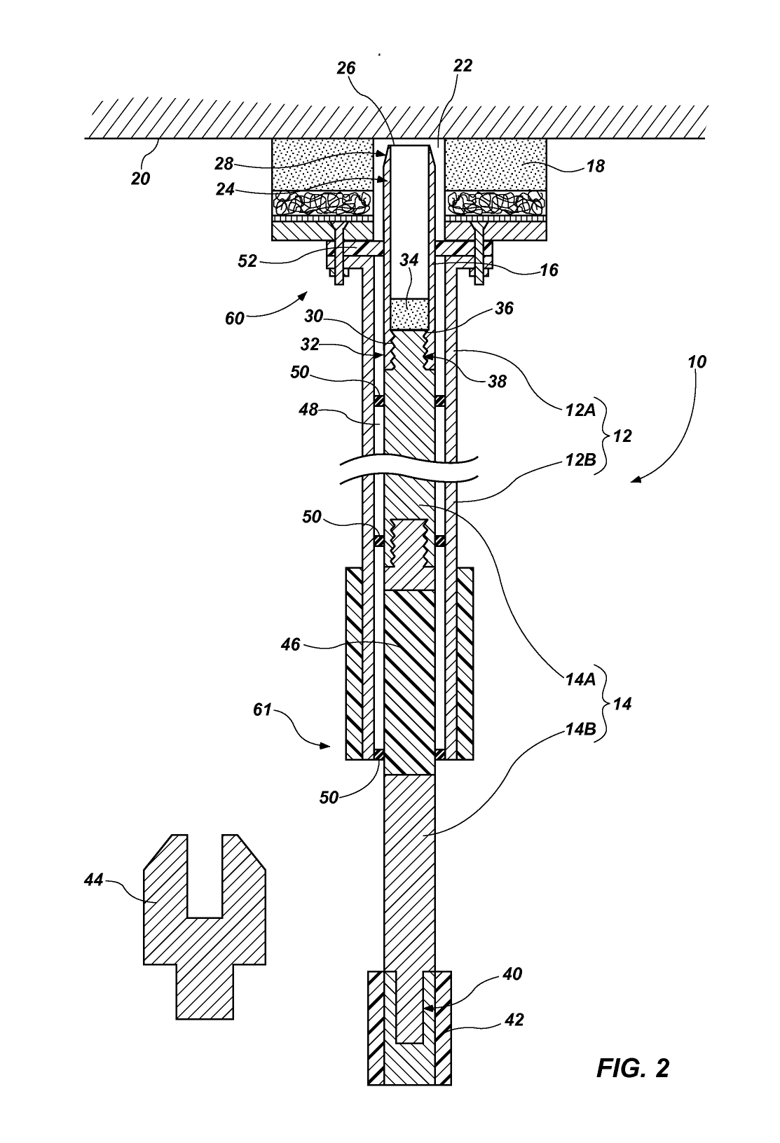

Referring to FIG. 2, a cross-sectional view of the sampling device 10 of FIG. 1 is shown in a first state. The first state may correspond to a pre-actuation state before a sample is taken. When in the first state, the dust inhibitor 18 may be abutted against a building surface 20. The building surface 20 may comprise, for example, a ceiling or a wall of a building from which a core sample of building material is to be taken. The core sampler 16 may be positioned in a hole 22 defined at least partially by the dust inhibitor 18. The core sampler 16 may abut against or be adjacent to the building surface 20.

The core sampler 16 may comprise, for example, a tube 24 including a piercing edge 26 at a first end 28 of the tube 24 and a connector 30 at a second, opposing end 32 of the tube 24. In some embodiments, the tube 24 may be sized to have an inner diameter of about 16 mm and an outer diameter of about 18 mm. The piercing edge 26 may be configured to penetrate the building surface 20 (e.g., a surface of a ceiling or wall) to enable the core sampler 16 to procure a core sample of building material and may comprise, for example, a leading edge formed by a chamfer at the first end 28 of the tube 24. The connector 30 may be configured to attach the core sampler 16 to the second shaft 14 and may comprise, for example, a threaded connection, interlocking tabs, a pinned connection, etc. A plug 34 may be disposed in the core sampler 16 at the second, opposing end 32 to retain a core sample within the core sampler 16 when the connector 30 is disconnected from the second shaft 14. A fresh core sampler 16 may be used for each sample of building material acquired.

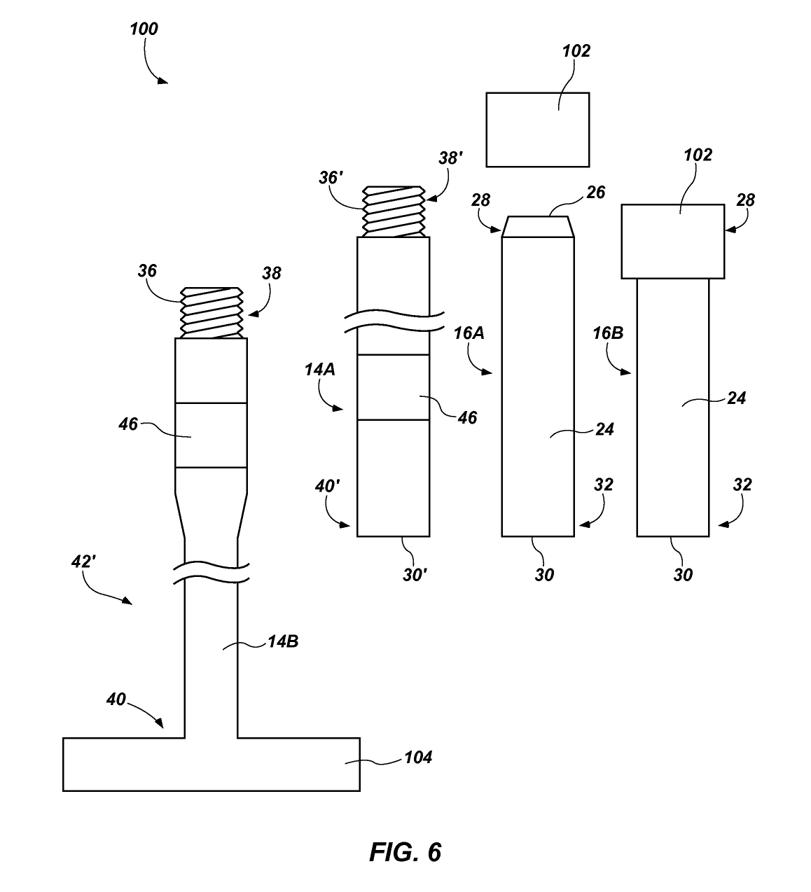

The second shaft 14 may comprise a connector 36 at a distal end 38 of the second shaft 14 configured to connect to the connector 30 of the core sampler 16. In embodiments where each connector 30 and 36 comprises a threaded connection, torque acting on the second shaft 14 and the core sampler 16 may tighten the connection between the second shaft 14 and the core sampler 16. A proximal end 40 of the second shaft 14 may be configured to be manipulated by a user to drive the core sampler 16 into the building surface 20. For example, the second shaft 14 may comprise a handle 42 to enable a user to grasp the second shaft 14 and to manually drive the core sampler 16 into the building surface 20. The handle 42 may be electrically insulative in some embodiments to reduce the likelihood that incidental contact of the sampling device 10 with live electrical wire will injure a user. In some embodiments, the handle 42 may include a cross member 104 (see FIG. 6) to provide a mechanical advantage (e.g., more leverage) to a user manually rotating the second shaft 14. As another example, the second shaft 14 may be connected to a drill chuck 44 configured to connect to a drill (not shown) to rotate the second shaft 14 and the core sampler 16 at low speeds to facilitate driving the core sampler 16 into the building surface 20. In such an example, the proximal end 40 of the second shaft 14 may comprise a hexagonal, square, or other polygonal cross-section to enable jaws of a corresponding drill chuck 44 to engage with the proximal end 40 of the second shaft 14. Accordingly, some embodiments of kits for assembling the sampling device 10 may include one or more handles 42 (e.g., with and without levers) and the drill chuck 44, and a user may select a handle 42 or a drill chuck 44 for connection to the second shaft 14 depending, for example, on user preference or on the materials to be punctured when procuring a core sample.

The second shaft 14 may include at least one insulative portion 46. For example, a portion 46 of one discrete shaft member 14B of the second shaft 14 may be formed from a insulative material, such as, for example, an electrically insulating polymer. In other embodiments, an entire discrete shaft member 14A or 14B or the entire second shaft 14 may be formed from a insulative material. The insulative material of the insulative portion 46 may prevent electricity from live wires that may be encountered while advancing the core sampler 16 from travelling through the second shaft 14 into a user.

The second shaft 14 may be movable within a bore 48 defined by and extending through the first shaft 12 to enable a user to drive the core sampler 16 attached to the distal end 38 of the second shaft 14 into the building surface 20 while maintaining the dust inhibitor 18 in contact with the building surface 20. For example, the core sampler 16 and the second shaft 14 may be inserted into the bore 48 at a proximal end 61 of the first shaft 12 and extend through the bore 48 beyond a distal end 60 of the first shaft 12. In some embodiments, one or more spacers 50 may be interposed between the first shaft 12 and the second shaft 14 in the bore 48 to maintain a distance between the first shaft 12 and the second shaft 14. The spacers 50 may comprise an insulative material, which may prevent electricity (e.g., from live wires) that may be encountered while advancing the core sampler 16 from travelling from the second shaft 14, through the first shaft 12, and into a user. In other embodiments, the second shaft 14 may be free to contact the first shaft 12 within the bore 48.

A sealing member 52 may be interposed between the hole 22 defined by the dust inhibitor 18 and the bore 48 defined by the first shaft 12 and may form a seal around at least one of the core sampler 16 and the second shaft 14. The sealing member 52 may prevent dust trapped within the hole 22 from moving into the bore 48 (e.g., by falling) and potentially escaping into the environment. The sealing member 52 may maintain a seal around the core sampler 16, the second shaft 14, or both as the core sampler 16 is advanced by a user into the building surface 20.

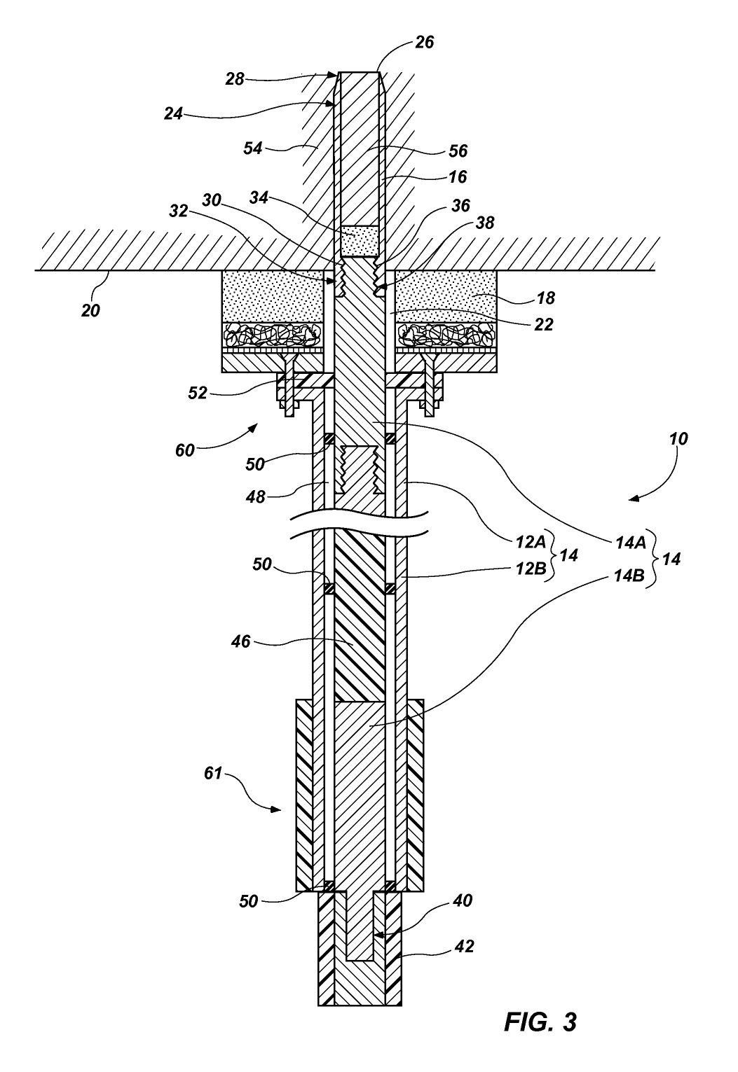

Referring to FIG. 3, a cross-sectional view of the sampling device 10 of FIG. 2 is shown in a second state. The second state may correspond to a post-actuation state to procure a sample. When in the second state, the dust inhibitor 18 may remain abutted against the building surface 20. The core sampler 16 may have advanced beyond the dust inhibitor 18, through the building surface 20, and into building material 54 from which a sample is to be obtained. A building material core sample 56 may be located within the core sampler 16 and configured for extraction. Dust produced by forcing the core sampler 16 through the building surface 20 and into the building material 54 may be collected by the dust inhibitor 18. For example, dust may be confined within the hole 22 and inhibited from escape into the surrounding environment.

To advance the core sampler 16 into the building material 54, a user may force the second shaft 14 to move within the first shaft 12 toward the building surface 20. In some embodiments, the user may rotate the second shaft 14 and the core sampler 16 while advancing the core sampler 16 into the building material 54. For example, the user may manually rotate the second shaft 14 and the core sampler 16 or may cause a drill (not shown) attached to the drill chuck 44 (see FIG. 2) to rotate the second shaft 14 and the core sampler 16. Rotation of the second shaft 14 and the core sampler 16 may be at relatively low speeds, such as, for example, below 250 RPM.

After the core sampler 16 has been driven into the building material 54, the core sampler 16 may be extracted along with the building material core sample 56. For example, the user may pull the second shaft 14 and the core sampler 16 away from the building surface 20 to extract the core sampler 16 from within the building material 54. The first shaft 12 may be pulled away from the building surface 20 at the same time as the second shaft 14, or the user may remove the second shaft 14 from within the first shaft 12 while maintaining the dust inhibitor 18 abutted against the building surface 20 and subsequently move the first shaft 12 away from the building surface 20. After the core sampler 16 has been extracted from within the building material 54, the core sampler 16 may be detached from the second shaft 14. The plug 34 may prevent the building material core sample 56 from falling out of the second, opposing end 32 of the tube 24. A core cap 102 (see FIG. 6) may be placed over the first end 28 of the tube 24 to seal the building material core sample 56 within the tube 24 during transport of the building material core sample 56 to a testing facility. Building material core samples 56 procured by such a sampling device 10 may include at least one material selected from the group consisting of wallboard, plaster, gypsum, and asbestos. For example, testing at the testing facility may reveal that hazardous material, such as, for example, asbestos, non-hazardous material, such as, for example, gypsum, or both is present in a building material core sample 56.

Sampling devices 10, as described herein, may be especially useful for procuring samples of ceiling materials without requiring use of a step ladder, or the like, in many instances. Accordingly, building material core samples 56 may be taken easily from many overhead sites in a relatively short time and with a relatively proximal exposure to potentially hazardous substances.

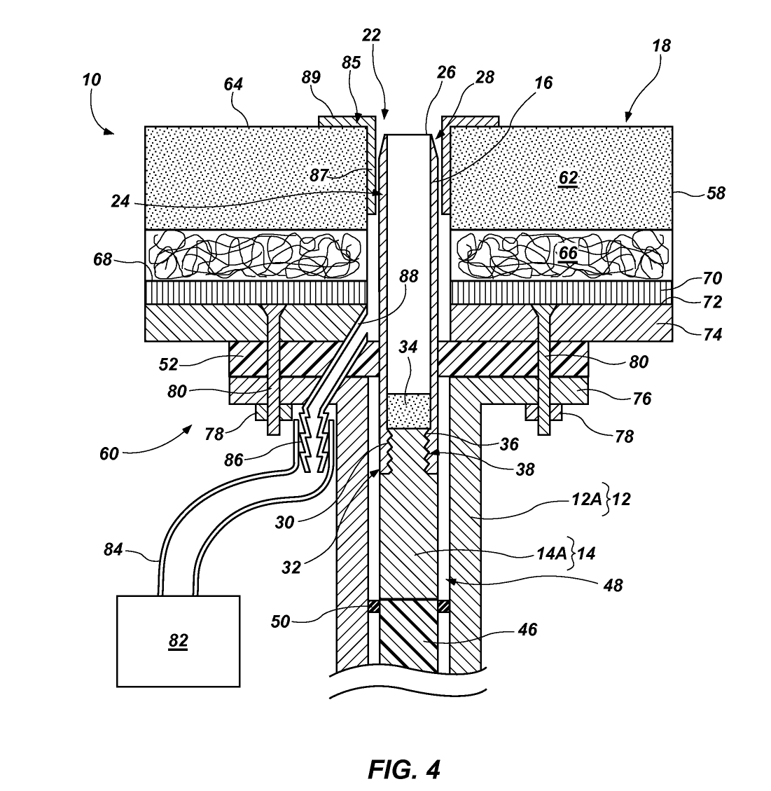

Referring to FIG. 4, a cross-sectional view of the dust inhibitor 18 of the sampling device 10 of FIG. 1 is shown. The dust inhibitor 18 may comprise a sponge device 58 attached to an end 60 (e.g., the distal end 60) of the first shaft 12. The sponge device 58 may comprise, for example, a porous mass 62 configured to absorb liquids on a first side 64 of the sponge device 58 configured to abut against a building surface 20 by way of an at least substantially planar or flat distal surface (see FIGS. 2 and 3). A hole 22 may be formed through the sponge device 58, which may enable the core sampler 16 to extend through the sponge device 58 when procuring a building material core sample 56 (see FIG. 3).

In some embodiments, a user may expose the porous mass 62 of the sponge device 58 to a liquid prior to abutting the sponge device 58 against a building surface 20 (see FIGS. 2 and 3). For example, the user may immerse the porous mass 62 in water to dampen the sponge device 58 before abutting the sponge device 58 against the building surface 20 (see FIGS. 2 and 3). Dust or other debris produced when procuring a building material core sample 56 (see FIG. 3) may adhere to damp surfaces of the porous mass 62 (e.g., the surfaces defining the hole 22), which may reduce the extent to which the dust or other debris may otherwise be able to escape into the surrounding environment.

The dust inhibitor 18 may be removably attached to the end 60 of the first shaft 12 using a hook-and-loop attachment (e.g., a hook-and-pile attachment or VELCRO® type attachment) to enable a user to detach the dust inhibitor 18 from the end 60 of the first shaft 12 for cleaning or other purposes and to swap the dust inhibitor 18 for other dust inhibitors, which may be substantially the same or significantly different from the dust inhibitor 18. The loop portion of the attachment may be located on the dust inhibitor 18 and may comprise, for example, a plurality of loops 66 (e.g., a scouring or scrubbing pad or other relatively more abrasive material) on a second, opposing side 68 of the sponge device 58. For example, sponges including scouring or scrubbing pads are commercially available and may be used with the sampling device 10 without requiring additional attachment structures (e.g., discrete pads of loops or hooks attached to the sponge), though other modifications of the sponges (e.g., forming the hole 22 through the sponges) may be performed. The hook portion of the attachment may be located on the end 60 of the first shaft 12 and may comprise a plurality of hooks 70. For example, a pad 72 from which the plurality of hooks 70 extends may be adhered or otherwise secured to a plate 74 at the end 60 of the first shaft 12. The plate 74 may be attached to a flange 76 extending from a telescoping shaft member 12A of the first shaft 12 using, for example, nuts 78 and bolts 80, screws, other attachment hardware, or an adhesive. A sealing member 52 may be sandwiched between the plate 74 and the flange 76 and may surround the core sampler 16 or the second shaft 14 to seal the hole 22 defined by the dust inhibitor 18 from the bore 48 defined by the first shaft 12. In other embodiments, the dust inhibitor 18 may be removably attached to the end 60 of the first shaft 12 by hooks on the dust inhibitor 18 and loops on the end 60 of the first shaft 12, an adhesive, clips, clamps, screws, or other removable attachments. In still other embodiments, the dust inhibitor 18 may be permanently secured to the end 60 of the first shaft 12.

In some embodiments, the dust inhibitor 18 may optionally be configured for attachment to a vacuum source 82 such as, for example, a vacuum pump, a vacuum cleaner, or any other suitable device configured to reduce an amount of potentially hazardous material to which a user may otherwise be exposed (e.g., a pump with HEPA filtration). For example, the vacuum source 82 may be connected by a hose 84 to a nozzle 86 at an end of a conduit 88 extending from within the hole 22 defined by the dust inhibitor 18 to an exterior of the dust inhibitor 18. When activated, the vacuum source 82 may remove some or all of the dust produced by procuring a building material core sample 56 (see FIG. 3) from within the hole 22 to reduce the extent to which the dust may otherwise be able to escape into the surrounding environment.

In some embodiments, a lip 89 may be interposed between the core sampler 16 and the dust inhibitor 18. For example, a lip 89 comprising tubular sleeve 87 and a radially extending flange 85 may be disposed between the core sampler 16 and the dust inhibitor 18, for example, by inserting the tubular sleeve 87 at least partially into the hole 22 defined by the sponge device 58 and abutting the flange 85 against the first side 64 (e.g., the distal surface) of the sponge device 58. The lip 89 may comprise a disposable material, such as, for example, paper or cardboard. The lip 89 may reduce the likelihood that the building material core sample 56 (see FIG. 3) will be contaminated by other materials (e.g., materials on or surrounding the building surface 20 that is penetrated to procure the sample or materials on surfaces of the sponge device 58). After the building material core sample 56 has been procured and properly secured, the lip 89 may be discarded and a new lip may be interposed between the core sampler 16 and the dust inhibitor 18 for each new sample acquired.

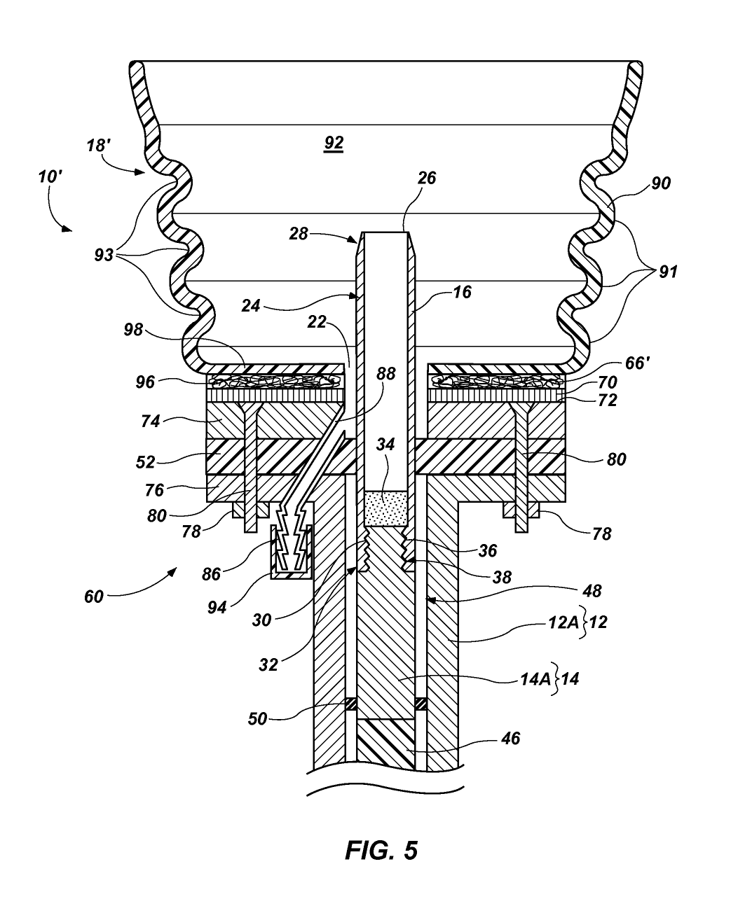

Referring to FIG. 5, a cross-sectional view of another embodiment of a dust inhibitor 18′ for a sampling device 10′ is shown. The dust inhibitor 18′ may comprise a suction cup 90 attached to the end 60 of the first shaft 12. The suction cup 90 may comprise, for example, a cup-shaped member configured to abut against a building surface 20 and optionally to produce a partial vacuum to adhere the dust inhibitor 18′ to a building surface 20 (see FIGS. 2 and 3). The suction cup 90 may include a series of accordion-like ridges 91 and valleys 93, which may enable the suction cup 90 to maintain a partial vacuum against the building surface 20 (see FIGS. 2 and 3) despite some incidental movement of the first shaft 12 during procurement of a building material core sample 56 (see FIG. 3).

In embodiments where the suction cup 90 is configured to produce a partial vacuum to adhere the dust inhibitor 18′ to the building surface 20 (see FIGS. 2 and 3), a cavity 92 defined by the suction cup 90 and the hole 22 extending through the suction cup 90 may be sealed off from an exterior of the suction cup 90. For example, the sealing member 52 may form a seal around the core sampler 16 or the second shaft 14 and the optional nozzle 86 may be closed off, for example, by connection to a vacuum source 82 (see FIG. 4) or using a cap 94. In other embodiments, the suction cup 90 may not seal against the building surface 20, but may simply be abutted against the building surface 20 (see FIGS. 2 and 3) and capture some or all of the dust and other debris released during procurement of a building material core sample 56 (see FIG. 3) within the cavity 92.

In some embodiments, the dust inhibitor 18′ may be removably attached to the end 60 of the first shaft 12 using a hook-and-loop attachment (e.g., a hook-and-pile attachment or VELCRO® type attachment) to enable a user to detach the dust inhibitor 18′ from the end 60 of the first shaft 12 for cleaning or other purposes and to swap the dust inhibitor 18′ for other dust inhibitors, which may be substantially the same or significantly different from the dust inhibitor 18′. For example, a sampling device 10 or 10′ or a kit for assembling a sampling device 10 or 10′ may include at least two dust inhibitors 18 and 18′, one comprising a sponge device 58 and the other comprising a suction cup 90, and a user may swap one for the other depending on the materials to be sampled, user preference, and the condition of the dust inhibitors 18 and 18′. The loop portion of the attachment may be secured to the dust inhibitor 18′ and may comprise a plurality of loops 66′ on a pad 96 adhered or otherwise secured to a proximal surface 98 of the suction cup 90. The hook portion of the attachment may be located on the end 60 of the first shaft 12 and may comprise a plurality of hooks 70. For example, a pad 72 from which the plurality of hooks 70 extends may be adhered or otherwise secured to a plate 74 at the end 60 of the first shaft 12. The plate 74 may be attached to a flange 76 extending from a telescoping shaft member 12A of the first shaft 12. The sealing member 52 may be sandwiched between the plate 74 and the flange 76 and may surround the core sampler 16 or the second shaft 14 to seal the hole 22 defined by the dust inhibitor 18 from the bore 48 defined by the first shaft 12. In other embodiments, the dust inhibitor 18 may be removably attached to the end 60 of the first shaft 12 by an adhesive, clips, clamps, screws, or other removable attachments.

In still other embodiments, the dust inhibitor 18′ may be permanently secured to the end 60 of the first shaft 12.

In some embodiments, the dust inhibitor 18′ may optionally be configured for attachment to a vacuum source 82 (see FIG. 4) configured to reduce an amount of potentially hazardous material to which a user may otherwise be exposed. For example, the dust inhibitor 18′ may comprise a nozzle 86 at an end of a conduit 88 extending from within the hole 22 extending through the dust inhibitor 18′ to an exterior of the dust inhibitor 18′. When activated, the vacuum source 82 (see FIG. 4) may remove some or all of the dust produced by procuring a building material core sample 56 (see FIG. 3) from within the hole 22 to reduce the extent to which the dust may otherwise be able to escape into the surrounding environment.

In some embodiments, a sponge device 58 (see FIG. 4) may optionally be disposed within the suction cup 90 and further define the hole 22 through which the core sampler 16 extends. In such embodiments, the sponge device 58 may be dampened with a liquid before procuring a building material core sample 56 (see FIG. 3) to reduce the extent to which the dust or other debris may otherwise be able to escape into the surrounding environment.

With reference to FIG. 6, a perspective view of a sampling device kit 100 is shown. The components of the sampling device kit 100 may be assembled with one another in various configurations to form a sampling device, such as, for example, the sampling devices 10 and 10′ described previously herein and variations thereof. The sampling device kit 100 may include at least one core sampler 16 configured to procure a building material core sample 56 (see FIG. 3). For example, the sampling device kit 100 may include a plurality of core samplers 16A and 16B configured to be used interchangeably with other components of the sampling device kit 100. Each core sampler 16A and 16B may comprise a tube 24, a piercing edge 26 configured to penetrate building material 54 (see FIG. 3) at a first end 28 of the tube 24, and a connector 30 at a second, opposing end 32 of the tube 24. The sampling device kit 100 may optionally include at least one core cap 102 configured for placement over the first end 28 of a core sampler 16 to seal a building material core sample 56 (see FIG. 3) within the core sampler 16 after such a building material core sample 56 (see FIG. 3) has been procured.

The sampling device kit 100 may include a second shaft 14B having a connector 36 at a distal end 38 thereof and comprising a handle 42′. The connector 36 of the second shaft 14B may be configured for connection to the connector 30 of each core sampler 16A and 16B, and optionally to other components of the sampling device kit 100. The second shaft 14B may be integrally formed with the handle 42′, or may be a discrete, unitary member configured for connection to the handle 42′ (see FIGS. 2 and 3). In some embodiments, the handle 42′ may comprise a cross member 104, such as, for example, levers extending radially outwardly from the second shaft 14B at a proximal end 40 of the second shaft 14B, which may provide a mechanical advantage (e.g., more leverage) to a user manually rotating the second shaft 14B. The second shaft 14B may comprise, for example, an insulative portion 46 to prevent electricity from live wires that may be encountered while advancing a core sampler 16A or 16B through a building material from travelling through the second shaft 14B into a user.

In some embodiments, the sampling device kit 100 may include at least one additional second shaft 14A configured to connect to the second shaft 14B at a proximal end 40′ thereof and to either a core sampler 16A or 16B or yet another shaft (not shown) at a distal end 38′ thereof to vary the length of the resulting sampling device 10 or 10′. For example, the additional second shaft 14A may comprise a connector 36′ at the distal end 38′ thereof configured to connect to the connector 30 of the core sampler 16A or 16B or to the other shaft (not shown) and another connector 30′ at the proximal end 40′ thereof configured to connect to the connector 38 of the second shaft 14B.

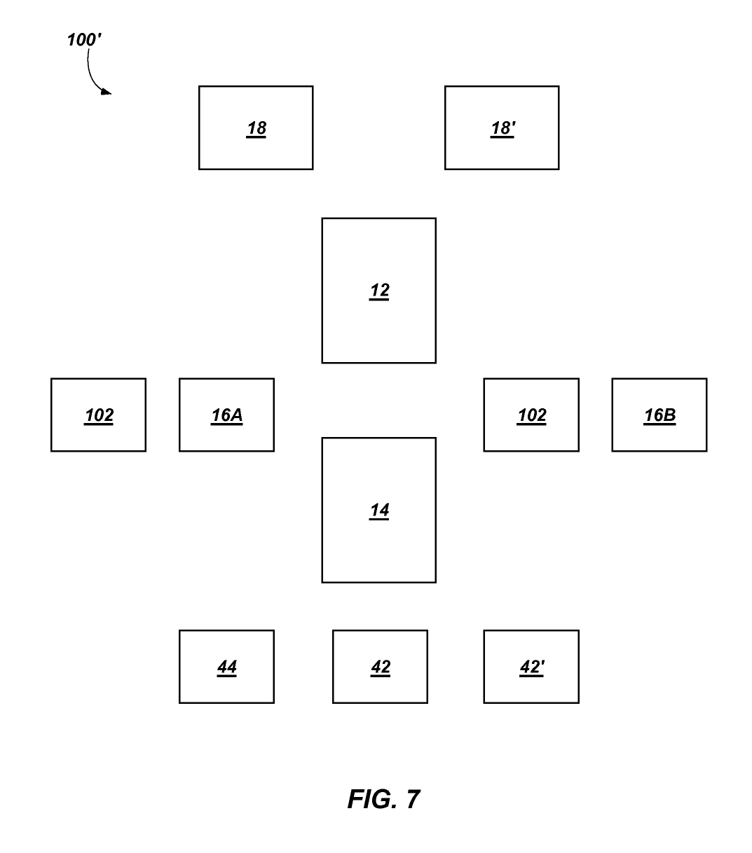

With reference to FIG. 7, a schematic of another embodiment of a sampling device kit 100′ is shown. The sampling device kit 100′ may include at least one core sampler 16, at least one optional core cap 102, a second shaft 14, as described previously in connection with FIG. 6. The sampling device kit 100 may include a first shaft 12, which may be extendable, in which the second shaft 14 and the core sampler 16 may be inserted, as described previously in connection with FIGS. 1 through 5. The sampling device kit 100′ may include at least one dust inhibitor 18 or 18′, such as any of those described previously in connection with FIGS. 4 and 5. For example, the sampling device kit 100 may include a plurality of dust inhibitors 18 and 18′, which may be interchangeably connected to the first shaft 12, to the second shaft 14, or to other components of the sampling device kit 100. The sampling device kit 100′ may include at least one of a drill chuck 44, a handle 42 comprising an electrically insulative material, and a handle 42′ comprising a cross member 104 (see FIG. 6). For example, the sampling device kit 100′ may include the drill chuck 44 and each handle 42 and 42′ for interchangeable connection to the second shaft 14.

When assembling a sampling device 10 or 10′ (see FIGS. 1 through 5) from a sampling device kit 100 or 100′, the second shaft 14B may be directly connected to a core sampler 16A or 16B in some embodiments. In other embodiments, the second shaft 14B may be connected to one or more additional second shafts 14A, which may ultimately be connected to a core sampler 16A or 16B. In some embodiments, the second shaft 14B, the core sampler 16A or 16B, and the optional additional second shaft or shafts 14A may be inserted into a first shaft 12 (see FIGS. 1 through 5). In some embodiments, a dust inhibitor 18 or 18′ may be attached to the first shaft 12 (see FIGS. 1 through 5) or may be attached to the second shaft 14B or another component of the sampling device kit 100′. After any of such assemblies have been completed, the piercing edge 26 of the core sampler 16A or 16B may be driven into a building material 54 and a building material core sample 56 may be procured (see FIG. 3). The core sampler 16A or 16B may be disconnected from the other components of the sampling device kit 100, the core cap 102 may be placed over the first end 28 of the tube 24 of the core sampler 16A or 16B, and the core sampler 16A or 16B, including the building material core sample 56 (see FIG. 3) contained therein, may be safely transported for testing. When it is desired to obtain more than one building material core sample 56 (see FIG. 3), another core sampler 16A or 16B may be interchanged for the one previously used to procure another building material core sample 56 (see FIG. 3). This process may be repeated for as many times as desired, so long as additional, unused core samplers 16 remain for connection to the other components of the sampling device kit 100 or 100′.

While certain illustrative embodiments have been described in connection with the figures, those of ordinary skill in the art will recognize and appreciate that embodiments of the disclosure are not limited to those embodiments explicitly shown and described herein. Rather, many additions, deletions, and modifications to the embodiments described herein may be made without departing from the scope of embodiments hereinafter claimed, including legal equivalents. In addition, features from one disclosed embodiment may be combined with features of another disclosed embodiment while still being encompassed within the scope of embodiments of the disclosure as contemplated by the inventor.

What is claimed is:

1. A sampling device configured to procure building material samples, comprising:
a first shaft comprising a distal end and a proximal end and defining a bore extending through the first shaft;
a second shaft configured for insertion into the bore at the proximal end of the first shaft, the second shaft comprising at least one insulative portion and a connector at a distal end of the second shaft;
a core sampler configured to procure a building material core sample, the core sampler comprising a coring tube having a piercing edge configured to penetrate a building material at a first end of the tube and a connector at a second, opposing end of the tube configured to connect to the connector at the distal end of the second shaft; and
at least one dust inhibitor defining a hole through which the core sampler is configured to extend, the at least one dust inhibitor configured to attach to the distal end of the first shaft and to abut against a building surface.

2. The sampling device of claim 1, wherein the second shaft is configured at its proximal end to engage with a drill chuck.

3. The sampling device of claim 1, wherein the second shaft comprises a handle at a proximal end opposing the distal end.

4. The sampling device of claim 1, wherein the at least one dust inhibitor comprises a plurality of interchangeable dust inhibitors.

5. The sampling device of claim 4, wherein at least one dust inhibitor of the plurality of dust inhibitors comprises a sponge device having a distal surface configured to abut against the building surface.

6. The sampling device of claim 4, wherein at least one dust inhibitor of the plurality of dust inhibitors comprises a suction cup and a sealing member configured to form a seal between the suction cup and at least one of the core sampler and the second shaft.

7. The sampling device of claim 1, wherein a combined length of the second shaft and the core sampler is greater than a length of the first shaft.

8. The sampling device of claim 7, wherein the second shaft comprises a plurality of shaft members configured to be connected to one another to vary the length of the second shaft.

9. A sampling device for procuring building material samples, comprising:
a first shaft defining a bore extending through the first shaft from a proximal end to a distal end;
a second shaft having a proximal end and a distal end and located at least partially within the bore of the first shaft, the second shaft comprising a connector at a distal end of the second shaft;
a core sampler configured to procure a building material core sample, the core sampler comprising a tube, a piercing edge configured to penetrate a building material at a first end of the tube, and a connector at a second, opposing end of the tube configured to connect to the connector at the distal end of the second shaft; and
a dust inhibitor configured to removably attach to the distal end of the first shaft and to abut against a building surface, the dust inhibitor comprising an aperture through which the core sampler is configured to extend.

10. The sampling device of claim 9, wherein the second shaft is configured to move within the first shaft such that the core sampler is extendable beyond the dust inhibitor.

11. The sampling device of claim 9, wherein the dust inhibitor comprises a sponge.

12. The sampling device of claim 11, wherein the dust inhibitor comprises a sealing member configured to form a seal between the dust inhibitor and at least one of the core sampler and the second shaft.

13. The sampling device of claim 12, wherein the dust inhibitor is configured for connection to a vacuum source.

14. A sampling device for procuring building material samples, comprising:
a core sampler configured to procure a building material core sample comprising a tube and a piercing edge configured to penetrate a building material at a first end of the tube; and
a dust inhibitor configured to abut against a building surface comprising a sponge through which the core sampler is configured to extend.

15. The sampling device of claim 14, wherein the core sampler comprises a connector at a second, opposing end of the tube and further comprising a first shaft defining a bore extending through the first shaft, wherein the dust inhibitor is attached to an end of the first shaft, and a second shaft located within the bore comprising a connector at a distal end to which the connector of the core sampler is connected.

16. The sampling device of claim 15, wherein the first shaft is extendable up to 20 feet (6.1 meters).

17. The sampling device of claim 15, wherein the second shaft comprises an insulative portion.

18. The sampling device of claim 15, wherein the end of the first shaft comprises a plurality of hooks attached to a plurality of loops located on a second side of the sponge opposing a first side configured to abut against the building surface.

19. The sampling device of claim 14, wherein the core sampler is configured to move relative to the dust inhibitor when procuring the building material core sample.

20. A sampling device kit, comprising:
a shaft comprising a threaded connector at a distal end thereof and a cross member at a proximal end of the shaft configured to apply a rotational force; and
at least one core sampler configured to procure a building material core sample comprising a tube, a piercing edge configured to penetrate a building material at a first end of the tube, and a complementary threaded connector at a second, opposing end of the tube configured to connect to the connector of the shaft.

21. The sampling device kit of claim 20, wherein the at least one core sampler comprises a plurality of core samplers configured to be interchangeably connected to the connector of the shaft.

22. A method of procuring a sample of building material, comprising:
abutting a dust inhibitor attached to a distal end of a first shaft against a building surface;
advancing a core sampler attached to a distal end of a second shaft located within a bore defined by the first shaft beyond the dust inhibitor at the distal end of the first shaft, through the building surface, and into a building material;
collecting at least some dust produced when advancing the core sampler into the building material within the dust inhibitor; and
extracting the core sampler along with a building material core sample from within the building material.

23. The method of claim 22, wherein extracting the building material core sample comprises extracting a building material core sample comprising at least one material selected from the group consisting of wallboard, plaster, gypsum, and asbestos.

24. The method of claim 22, wherein abutting the dust inhibitor against the building surface comprises abutting the dust inhibitor against a ceiling.
